(19) United States
(12) Patent Application Publication
(10) Pub. No.: US 2026/0089036 A1
(43) Pub. Date: Mar. 26, 2026

(54) SEMICONDUCTOR DEVICE AND TRANSMISSION DEVICE

(71) Applicant: Kioxia Corporation, Tokyo (JP)

(72) Inventor: Tomohiro TAMURA, Ota Tokyo (JP)

(21) Appl. No.: 19/080,173

(22) Filed: Mar. 14, 2025

(30) Foreign Application Priority Data
Sep. 20, 2024 (JP) 2024-164254

(51) Int. Cl. H04L 25/02; H04B 1/401; H04B 3/02

(52) U.S. Cl. CPC H04L 25/0272; H04B 1/401; H04B 3/02

(57) ABSTRACT

A semiconductor device includes a first circuit configured to receive a first signal, which is a differential parallel signal, and output a second signal, which is a differential serial signal, based on the first signal. The first circuit includes a second circuit configured to convert the first signal to a third signal, which is a differential serial signal, a third circuit configured to receive the third signal and output the second signal, which corresponds to the third signal, a fourth circuit configured to receive the third signal and output a fourth signal corresponding to the third signal selectively during a predetermined operation mode, and a fifth circuit configured to receive the fourth signal and output a fifth signal obtained by buffering the fourth signal.

### CROSS-REFERENCE TO RELATED APPLICATIONS

This application is based upon and claims the benefit of priority from Japanese Patent Application No. 2024-164254, filed Sep. 20, 2024, the entire contents of which are incorporated herein by reference.

### FIELD

Embodiment described herein relates generally to a semiconductor device and a transmission device.

### BACKGROUND

M-PHY is attracting attention as a circuit for performing high-speed serial transmission in electronic equipment such as a smartphone. The M-PHY is a standard developed by the Mobile Industry Processor Interface (MIPI) alliance. In the M-PHY standard, amplitude levels of output signals are limited in order to operate with low-power consumption.

A transmission device compatible with the M-PHY standard needs to be provided with an internal loopback (ILB) test circuit for monitoring data transmitted to a reception device.

However, when creating a branch in a high-speed serial signal path of the transmission device to connect the path to the ILB test circuit, characteristics of the serial signal output from the transmission device may deteriorate due to the path being connected to the ILB test circuit. A circuit scale of the transmission device increases as well as power consumption by providing the ILB test circuit. In other words, in a transmission device including a circuit for performing an output signal test, there has been a demand for performing the output signal test without causing the characteristics of the output signal to deteriorate. Further, there has been a need for being able to suppress an increase in circuit scale of the circuit for performing the output signal test and the increase in power consumption.

### BRIEF DESCRIPTION OF THE DRAWINGS

FIG. 1 is a block diagram schematically illustrating a configuration of a communication system according to an embodiment.

FIG. 2 is a block diagram schematically illustrating a configuration of a transmission device according to the embodiment.

FIG. 3 is a block diagram illustrating an example of an internal configuration of a parallel-in serial-out (PISO) circuit.

FIG. 4 is a block diagram illustrating an internal configuration of a source serial termination (SST) circuit.

FIG. 5 is a circuit diagram illustrating an example of an internal configuration of one SST unit.

FIG. 6A is a circuit diagram illustrating an example of an internal configuration of an SST driver in FIG. 5.

FIG. 6B is a circuit diagram illustrating an example of an internal configuration of a dummy driver in FIG. 5.

FIG. 7 is a circuit diagram illustrating an example of an internal configuration of an SST unit according to a comparative example.

### DETAILED DESCRIPTION

An object of one or more embodiments according to the present disclosure is to provide a semiconductor device and a transmission device that are capable of suppressing an increase in circuit scale of a circuit for performing an output signal test and an increase in power consumption, without causing characteristics of an output signal to deteriorate.

In general, according to one or more embodiments, a semiconductor device includes a first circuit configured to receive a first signal, which is a differential parallel signal, and output a second signal, which is a differential serial signal, based on the first signal. The first circuit includes a second circuit configured to convert the first signal to a third signal, which is a differential serial signal, a third circuit configured to receive the third signal and output the second signal, which corresponds to the third signal, a fourth circuit configured to receive the third signal and output a fourth signal corresponding to the third signal selectively during a predetermined operation mode, and a fifth circuit configured to receive the fourth signal and output a fifth signal obtained by buffering the fourth signal.

Hereinafter, one or more embodiments of the semiconductor device and the transmission device will be described with reference to the drawings. In the following description, main components of the semiconductor device and the transmission device will mainly be described, but the semiconductor device and the transmission device may include components and functions not illustrated or described. The description below is not intended to exclude components and functions not illustrated or described.

FIG. 1 is a block diagram schematically illustrating a configuration of a communication system 1 according to an embodiment. The communication system 1 in FIG. 1 includes a transmission device 2, a reception device 3, and a differential transmission line 4. The transmission device 2 and the reception device 3 perform high-speed serial transmission via the differential transmission line 4. More specifically, the transmission device 2 outputs a differential serial signal to the differential transmission line 4. The transmission device 2 has a function of converting a parallel signal to the differential serial signal. The differential serial signal output by the transmission device 2 is, for example, a signal that is encoded using a predetermined format. The encoding format is not limited, but an example of encoding a binary signal using pulse-amplitude modulation (PAM) is described in the present disclosure.

The reception device 3 receives the differential serial signal from the transmission device 2 and decodes the differential serial signal into an original binary signal. A length of the differential transmission line 4 is not limited. The transmission device 2 and the reception device 3 may be implemented on separate semiconductor chips or may be implemented in the same semiconductor package.

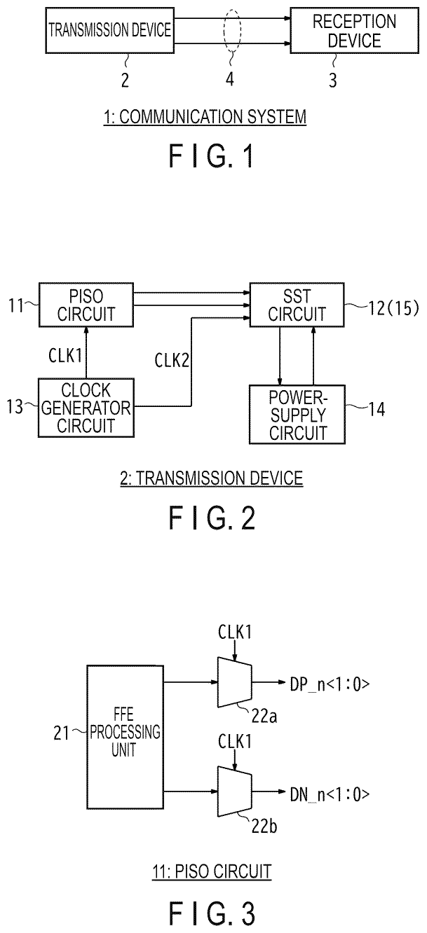

FIG. 2 is a block diagram schematically illustrating a configuration of the transmission device 2 according to the embodiment. The transmission device 2 in FIG. 2 includes a parallel-in serial-out (PISO) circuit 11, a source serial termination (SST) circuit 12, a clock generator circuit 13, and a power-supply circuit 14. These circuits may be implemented on a semiconductor chip. The SST circuit 12 constitutes a part of the semiconductor device according to the embodiment. The PISO circuit 11, the SST circuit 12, the clock generator circuit 13, and the power-supply circuit 14 may be implemented on one semiconductor chip or may be implemented on separate semiconductor chips. The PISO circuit 11, the SST circuit 12, the clock generator circuit 13, and the power-supply circuit 14 may be implemented as one semiconductor device or may be implemented as separate semiconductor devices.

The PISO circuit 11 outputs first signals that are parallel signals or serial signals. For example, the PISO circuit 11 outputs the first signals obtained by converting parallel signals to serial signals. For example, the PISO circuit 11 converts sixth signals that are parallel signals of a first bit string to the first signals that are parallel signals of a second bit string having a smaller number of bits than the first bit string, and outputs the first signals. In the present specification, the PISO circuit 11 may be referred to as a converter circuit.

The SST circuit 12 outputs second signals that are serial signals, based on the first signals output from the PISO circuit 11. The second signals are, for example, differential serial signals. In the present disclosure, the SST circuit 12 may be referred to as a first circuit.

The clock generator circuit 13 generates a first clock signal CLK1 that is used to synchronize the first signals output from the PISO circuit 11, and a second clock signal CLK2 that is used to synchronize the second signals output from the SST circuit 12. The second clock signal CLK2 is, for example, a frequency-divided signal of the first clock signal CLK1.

As described below, the power-supply circuit 14 controls a power-supply voltage provided to a part of a circuit in the SST circuit 12 in accordance with an operation mode.

The power-supply circuit 14 may be, for example, a low-dropout (LDO) regulator. An LDO regulator can operate even with a small voltage difference between an input voltage and an output voltage thereof, is capable of suppressing heat generation, and has superior power efficiency.

FIG. 3 is a block diagram illustrating an example of an internal configuration of the PISO circuit 11. The PISO circuit 11 in FIG. 3 includes a feed-forward equalization (FFE) processing unit 21, and two multiplexers 22a and 22b.

The FFE processing unit 21 performs FFE processing of raising the gain of the Nyquist frequency related to a data transmission bandwidth, when converting the sixth signals that are parallel signals to the first signals. The FFE processing is processing of compensating for waveform rounding in the differential serial signal output by the transmission device 2, inter-symbol interference (ISI), and the like.

The PISO circuit 11 outputs the first signals obtained by the FFE processing unit 21 performing the FFE processing. The first signals are, for example, differential parallel or serial signals. In the present disclosure, an example is mainly described of the PISO circuit 11 outputting the first signals that are differential parallel signals. For example, the PISO circuit 11 outputs M pairs of differential first signals DP_n<1:0> and DN_n<1:0>. M is an arbitrary integer of 2 or higher. The PISO circuit 11 outputs M pairs of first signals DP_n<1> and DN_n<1> at a timing obtained by shifting the first clock signal CLK1 half a period, after synchronizing the M pairs of first signals DP_n<0> and DN_n<0> to the first clock signal CLK1 and outputting the M pairs of first signals DP_n<0> and DN_n<0> at the same timing.

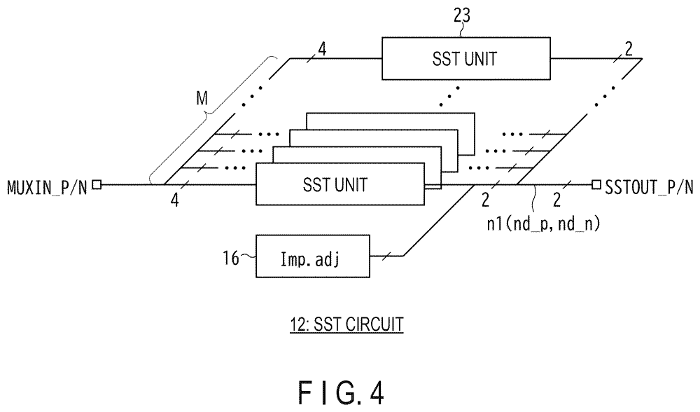

FIG. 4 is a block diagram illustrating an internal configuration of the SST circuit 12. The SST circuit 12 includes M SST units 23 connected in parallel and one or more impedance adjuster circuits (Imp. adj) 16. The M SST units 23 correspond to the M pairs of differential first signals DP_n<1:0> and DN_n<1:0> output from the PISO circuit 11. In other words, input signals MUXIN_P and MUXIN_N of each SST unit 23 are a corresponding pair of first signals DP_n<1:0> and DN_n<1:0> output from the PISO circuit 11.

Each SST unit 23 outputs differential signals OUT_P and OUT_N obtained by converting the corresponding pair of first signals DP_n<1:0> and DN_n<1:0> to serial signals.

Output nodes nd of the M SST units 23 are connected to one another. In the present disclosure, nodes at which the output nodes nd of the M SST units 23 are connected to one another are referred to as common connection nodes n1. More precisely, among the differential signals OUT_P and OUT_N output from each SST unit 23, output nodes nd_p that output one signal OUT_P are connected to one another and output nodes nd_n that output the other signal OUT_N are connected to one another. In the present disclosure, the output nodes nd_p and nd_n may be denoted as the output nodes nd.

When the PISO circuit 11 outputs a PAM4 signal, any four first signals DP_n<1:0> and DN_n<1:0> are output in parallel. These four first signals DP_n<1:0> and DN_n<1:0> are output to one corresponding SST unit 23. Each SST unit 23 generates the signals OUT_P and OUT_N that are differential serial signals. Voltage levels of the signals OUT_P and OUT_N generated in parallel by each SST unit 23 may be different. However, no problem occurs even when the output nodes nd of each SST unit 23 are connected to the common connection nodes n1.

In this manner, the SST circuit 12 outputs differential second signals SSTOUT_P and SSTOUT_N obtained by combining the M differential signals OUT_P and OUT_N generated in parallel by the M SST units 23 at the common connection nodes n1.

The impedance adjuster circuit 16 is connected to the common connection nodes n1. In FIG. 4, one impedance adjuster circuit 16 is illustrated, but a plurality of impedance adjuster circuits 16 may be connected to the common connection nodes n1. The number of impedance adjuster circuits 16 may be any suitable number. Each of the plurality of impedance adjuster circuits 16 has the same circuit configuration and the same output resistance. The impedance adjuster circuit 16 has a configuration enabling adjustment of the output impedance of the SST circuit 12.

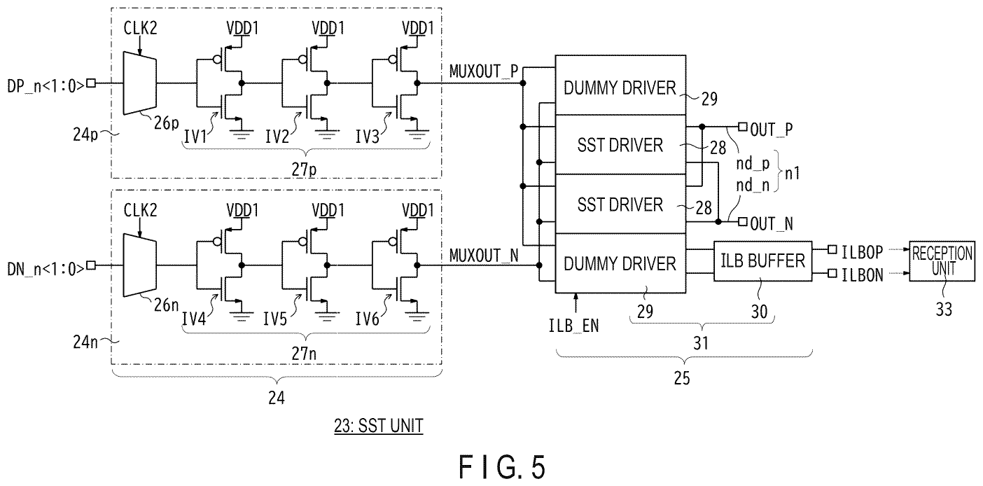

The M SST units 23 have a common circuit configuration. FIG. 5 is a circuit diagram illustrating an example of an internal configuration of one SST unit 23. The SST unit 23 according to the present embodiment includes an ILB test circuit 31 connected on a high-speed serial transmission path. The ILB test circuit 31 is a circuit for monitoring, during an ILB test mode, a serial signal that the transmission device 2 is to transmit to the reception device 3. The ILB test mode is an operation mode for executing an ILB test. Fifth signals ILBOP and ILBON output from the ILB test circuit 31 are received by a reception unit 33 in the transmission device 2.

A first enable signal ILB_EN for alternatively selecting the ILB test mode or a normal operation mode is input to each SST unit 23.

As illustrated in FIG. 5, each of the M SST units 23 includes a serial signal generator circuit 24 and a driver circuit 25. As illustrated in FIG. 4, the output nodes nd of each SST unit 23 are all connected to the common connection nodes n1 of the SST circuit 12. In FIG. 5, the impedance adjuster circuit 16 connected to the output nodes n1 as illustrated in FIG. 4 is omitted.

The serial signal generator circuit 24 converts the first signals DP_n<1:0> and DN_n<1:0> output from the PISO circuit 11 to third signals MUXOUT_P and MUXOUT_N that are differential serial signals respectively, and outputs the third signals MUXOUT_P and MUXOUT_N. In the present disclosure, the serial signal generator circuit 24 may be referred to as a second circuit.

The serial signal generator circuit 24 includes a first serial signal generator 24p for the first signal DP_n<1:0> and a second serial signal generator 24n for the first signal DN_n<1:0>.

The first serial signal generator 24p includes a multiplexer 26p and a buffer circuit 27p. The multiplexer 26p synchronizes the first signal DP_n<1:0> to the second clock signal CLK2 and serializes the first signal DP_n<1:0>. The buffer circuit 27p includes a plurality of inverters IV1 to IV3 connected in cascade, and inverts a logic level of the serial signal output from the multiplexer 26p a plurality of times. A power-supply voltage VDD1 is provided to each of the plurality of inverters IV1 to IV3. The number of stages of inverters provided in the buffer circuit 27p may be any suitable number. The third signal MUXOUT_P obtained by serializing the first signal DP_n<1:0> is output from an output node of the buffer circuit 27p.

The second serial signal generator 24n includes a multiplexer 26n and a buffer circuit 27n. The multiplexer 26n synchronizes the first signal DN_n<1:0> to the second clock signal CLK2 and serializes the first signal DN_n<1:0>. The buffer circuit 27n includes a plurality of inverters IV4 to IV6 connected in cascade, and inverts a logic level of the serial signal output from the multiplexer 26n a plurality of times. The power-supply voltage VDD1 is provided to each of the plurality of inverters IV4 to IV6. The number of stages of inverters provided in the buffer circuit 27n may be any suitable number. The third signal MUXOUT_N obtained by serializing the first signal DN_n<1:0> is output from an output node of the buffer circuit 27n.

The driver circuit 25 includes a plurality of SST drivers 28 and a plurality of dummy drivers 29. FIG. 5 illustrates an example of two SST drivers 28 and two dummy drivers 29 being provided in the driver circuit 25, but this is merely an example. The number of SST drivers 28 and the number of dummy drivers 29 in the driver circuit 25 may be any number. For example, the driver circuit 25 may include a plurality (for example, four) of SST drivers 28 without including the dummy driver 29. Alternatively, the driver circuit 25 may include three SST drivers 28 and one dummy driver 29.

The driver circuit 25 outputs the signals OUT_P and OUT_N corresponding to the third signals MUXOUT_P and MUXOUT_N output from the serial signal generator circuit 24. The signals OUT_P and OUT_N are output from the SST drivers 28 in the driver circuit 25. When the driver circuit 25 includes a plurality of SST drivers 28, output nodes of the SST drivers 28 are connected to each other and to the output nodes nd_p and nd_n, and the signals OUT_P and OUT_N are output from these output nodes nd_p and nd_n.

The SST drivers 28 output the signals OUT_P and OUT_N that are differential serial signals corresponding to the differential third signals MUXOUT_P and MUXOUT_N output from the serial signal generator circuit 24. In the present disclosure, the SST driver 28 may be referred to as a third circuit.

An ILB buffer 30 is connected to output nodes of the dummy driver 29 included in the driver circuit 25. The ILB test circuit 31 is constituted by the dummy driver 29 and the ILB buffer 30. The dummy driver 29 and the ILB buffer 30 of the ILB test circuit 31 output, during the ILB test mode, the fifth signals ILBOP and ILBON corresponding to the second signals to be transmitted to the reception device 3. The fifth signals ILBOP and ILBON are generated based on the third signals MUXOUT_P and MUXOUT_N output from the serial signal generator circuit 24.

The dummy driver 29 outputs, during a predetermined operation mode (for example, the ILB test mode), fourth signals that are differential serial signals corresponding to the differential third signals MUXOUT_P and MUXOUT_N output from the serial signal generator circuit 24. In the present disclosure, the dummy driver 29 may be referred to as a fourth circuit.

The ILB buffer 30 is connected to the output nodes of the dummy driver 29. The ILB buffer 30 outputs the differential fifth signals ILBOP and ILBON obtained by buffering the differential fourth signals. In the present disclosure, the ILB buffer 30 may be referred to as a fifth circuit.

The dummy driver 29 has a circuit configuration resembling that of the SST driver 28. More specifically, a conductivity type and a size of at least a part of transistors constituting the dummy driver 29 are the same as a conductivity type and a size of transistors constituting the SST driver 28.

It is noted that not all of the SST units 23 need to include the ILB test circuit 31. Depending on the SST unit 23, the driver circuit 25 in the SST unit 23 may not include the dummy driver 29. The SST units 23 not including the dummy driver 29 do not include the ILB test circuit 31. The ILB buffer 30 need not be connected to the output nodes of all dummy drivers 29. In other words, at least a part of the plurality of SST units 23 included in the SST circuit 12 includes the ILB test circuit 31.

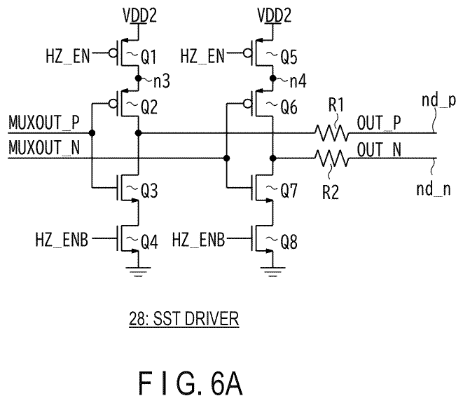

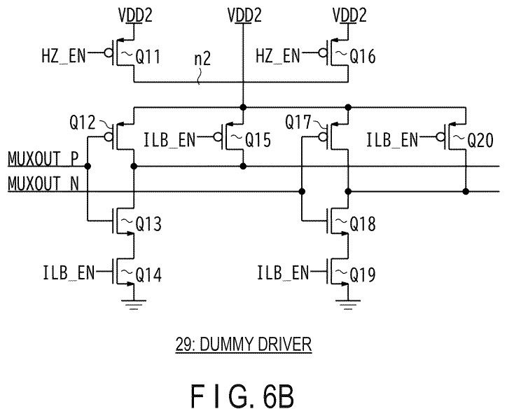

FIG. 6A is a circuit diagram illustrating an example of an internal configuration of the SST driver 28 in FIG. 5. The SST driver 28 illustrated in FIG. 6A includes PMOS transistors Q1 and Q2 and NMOS transistors Q3 and Q4 connected in cascade between a power-supply voltage node that provides a power-supply voltage VDD2 and a ground voltage node, PMOS transistors Q5 and Q6 and NMOS transistors Q7 and Q8 connected in cascade between the power-supply voltage node the ground voltage node, and resistors R1 and R2. The power-supply voltage node is a node for providing a power-supply potential to the SST driver 28 and the dummy driver 29. The ground voltage node is a node for providing a reference potential when the SST driver 28 and the dummy driver 29 operate. The power-supply voltage VDD2 is configurable with a potential independent from the power-supply voltage VDD1 that is provided to the plurality of inverters IV1 to IV6 of the serial signal generator circuit 24.

A second enable signal HZ_EN is input to both a gate of the transistor Q1 and a gate of the transistor Q5. The third signal MUXOUT_P output from the serial signal generator circuit 24 is input to both a gate of the transistor Q2 and a gate of the transistor Q3. An internal node n3 is connected to a drain of the transistor Q1 and a source of the transistor Q2. One end of the resistor R1 is connected to both a drain of the transistor Q2 and a drain of the transistor Q3. The other end of the resistor R1 is connected to the output node nd_p of the SST unit 23.

An inverted signal HZ_ENB of the second enable signal HZ_EN is input to both a gate of the transistor Q4 and a gate of the transistor Q8. The third signal MUXOUT_N output from the serial signal generator circuit 24 is input to both a gate of the transistor Q6 and a gate of the transistor Q7. An internal node n4 is connected to a drain of the transistor Q5 and a source of the transistor Q6. One end of the resistor R2 is connected to both a drain of the transistor Q6 and a drain of the transistor Q7. The other end of the resistor R2 is connected to the output node nd_n of the SST unit 23.

When the second enable signal HZ_EN is at a low level (HZ_ENB is at a high level), the transistors Q1, Q4, Q5, and Q8 are on, the transistors Q2 and Q3 function as an inverter, and the transistors Q6 and Q7 also function as an inverter. At this time, the signals OUT_P and OUT_N corresponding to the third signals MUXOUT_P and MUXOUT_N output from the serial signal generator circuit 24 are output from the output nodes nd_p and nd_n of the SST unit 23.

When the second enable signal HZ_EN is at a high level (HZ_ENB is at a low level), the output nodes nd_p and nd_n of the SST unit 23 are at a high impedance.

The resistor R1 connected to both the drain of the transistor Q2 and the drain of the transistor Q3 and the resistor R2 connected to both the drain of the transistor Q6 and the drain of the transistor Q7 have the same resistance value. By adjusting the resistance values of the resistors R1 and R2, the output impedance of the SST unit 23 can be adjusted.

FIG. 6B is a circuit diagram illustrating an example of an internal configuration of the dummy driver 29 in FIG. 5. The dummy driver 29 illustrated in FIG. 6B has a circuit configuration resembling that of the SST driver 28 illustrated in FIG. 6A. Specifically, the dummy driver 29 illustrated in FIG. 6B includes PMOS transistors Q11 and Q12, NMOS transistors Q13 and Q14, PMOS transistors Q15, Q16, and Q17, NMOS transistors Q18 and Q19, and PMOS transistor Q20.

Both a source of the transistor Q11 and a source of the transistor Q16 are connected to a power-supply voltage node that provides a power-supply voltage VDD2, and both a drain of the transistor Q11 and a drain of the transistor Q16 are connected to an internal node n2. The transistors Q12 to Q14 are connected in cascade between the power-supply voltage node and the ground voltage node. The third signal MUXOUT_P output from the serial signal generator circuit 24 is input to both a gate of the transistor Q12 and a gate of the transistor Q13.

A source of the transistor Q15 is connected to the power-supply voltage node, and a drain of the transistor Q15 is connected to both a drain of the transistor Q12 and a drain of the transistor Q13. The first enable signal ILB_EN is input to a gate of the transistor Q14 and a gate of the transistor Q15. The second enable signal HZ_EN is input to a gate of the transistor Q11 and a gate of the transistor Q16.

The transistors Q17 to Q19 are connected in cascade between the power-supply voltage node and the ground voltage node. The third signal MUXOUT_N output from the serial signal generator circuit 24 is input to both a gate of the transistor Q17 and a gate of the transistor Q18.

A source of the transistor Q20 is connected to the power-supply voltage node, and a drain of the transistor Q20 is connected to both a drain of the transistor Q17 and a drain of the transistor Q18. The first enable signal ILB_EN is input to a gate of the transistor Q19 and a gate of the transistor Q20.

The internal node n2 connected to both the drain of the transistor Q11 and the drain of the transistor Q16 has the power-supply voltage VDD2 when the second enable signal HZ_EN is at a low level and is at a high impedance when the second enable signal HZ_EN is at a high level. In this manner, the internal node n2 of the dummy driver 29 has the same potential as the internal nodes (first internal nodes) n3 and n4 connected respectively to the drain of the transistor Q1 and the drain of the transistor Q5 of the SST driver 28 illustrated in FIG. 6A. The internal nodes n3 and n4 of the SST driver 28 and the internal node (second internal node) n2 of the dummy driver 29 are electrically connected via a wiring pattern or the like. By providing the dummy driver 29, the output impedance of the SST unit 23 can be adjusted. The SST circuit 12 includes M SST units 23, and by providing the dummy driver 29 in at least a part of the M SST units 23 among the M SST units 23, the output impedance of the M SST units 23 can be equalized.

When the second enable signal HZ_EN is at a low level (HZ_ENB is at a high level), the first enable signal ILB_EN is controlled to be at a low level. This case is the normal operation mode in which the output nodes of the dummy driver 29 are at a level corresponding to the power-supply voltage VDD2, since the transistors Q14 and Q19 are off and the transistors Q15 and Q20 are on.

In the normal operation mode, the second enable signal HZ_EN is at a low level (HZ_ENB is at a high level), and the SST driver 28 illustrated in FIG. 6A outputs the signals OUT_P and OUT_N corresponding to the third signals MUXOUT_P and MUXOUT_N. Since the internal nodes n2 to n4 of the SST driver 28 and the dummy driver 29 are electrically connected to one another, providing an output level corresponding to the power-supply voltage VDD2 of the signals OUT_P and OUT_N can be enhanced. It is noted that in the dummy driver 29, a node between the transistors Q13 and Q14 and a node between the transistors Q18 and Q19 may be connected in an isolated manner like the internal node n2. A node connected to a drain of the transistor Q14 and a node connected to a drain of the transistor Q19 are respectively connected to a node between the transistors Q3 and Q4 and a node between the transistors Q7 and Q8 in the SST driver 28. According to such a configuration, providing an output level corresponding to a ground potential of the signals OUT_P and OUT_N can be enhanced.

When the second enable signal HZ_EN is at a high level, the first enable signal ILB_EN is controlled to be at a high level. This case is the ILB test mode in which the transistors Q14 and Q19 are on and the transistors Q15 and Q20 are off in the dummy driver 29. Therefore, Q12 and Q13 function as an inverter and Q17 and Q18 also function as an inverter. With this, the dummy driver 29 outputs the fourth signals corresponding to the third signals MUXOUT_P and MUXOUT_N output from the serial signal generator circuit 24.

The power-supply circuit 14 switches, during the normal operation mode and the ILB test mode, a voltage level of the power-supply voltage VDD2 provided to the driver circuit 25. During the normal operation mode, the voltage level of the power-supply voltage VDD2 is lower than during the ILB test mode. With this, power consumption during high-speed serial transmission can be reduced. During the ILB test mode, the fifth signals ILBOP and ILBON received by the reception unit 33 of the transmission device 2 are less susceptible to the influence of noise and the reliability of the ILB test can be improved, by increasing the voltage level of the power-supply voltage VDD2.

More specifically, the power-supply circuit 14 sets the power-supply voltage VDD1 of the serial signal generator circuit 24 and the power-supply voltage VDD2 of the driver circuit 25 to be at the same voltage level during the ILB test mode. On the other hand, the power-supply circuit 14 sets the power-supply voltage VDD2 of the driver circuit 25 to be lower than the power-supply voltage VDD1 of the serial signal generator circuit 24 during the normal operation mode.

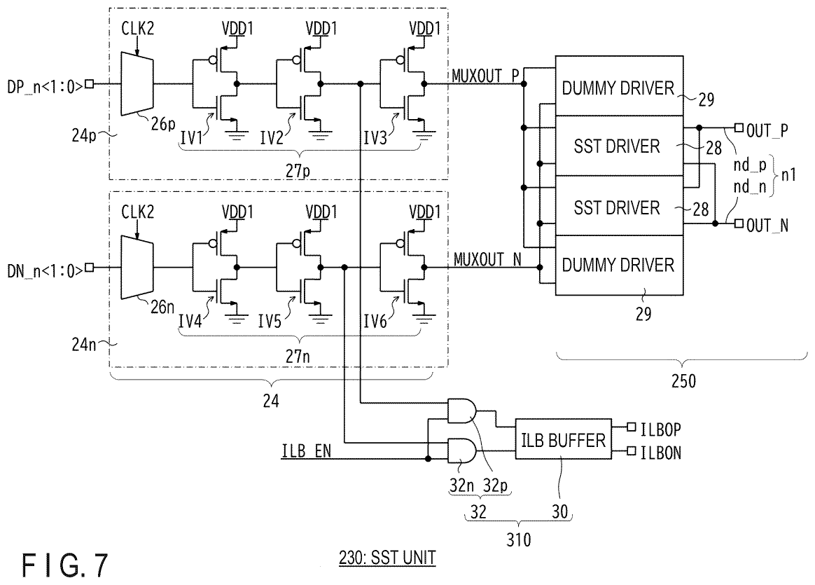

FIG. 7 is a circuit diagram illustrating an example of an internal configuration of an SST unit 230 according to a comparative example. In FIG. 7, circuit elements common to those in FIG. 5 are given the same reference signs, and differences therefrom will mainly be described below. In the SST unit 230 according to the comparative example, an ILB test circuit 310 is not provided in the driver circuit 25, but on a path branched off from the serial signal generator circuit 24.

More specifically, the ILB test circuit 310 according to the comparative example includes a logic circuit 32 and the ILB buffer 30. The logic circuit 32 is connected to an output node of the inverter IV2 in the buffer circuit 27p and an output node of the inverter IV5 in the buffer circuit 27n, the buffer circuit 27p and the buffer circuit 27n being in the serial signal generator circuit 24.

The logic circuit 32 includes a first AND circuit 32p that generates a logical product signal of an output signal of the inverter IV2 and the first enable signal ILB_EN, and a second AND circuit 32n that generates a logical product signal of an output signal of the inverter IV5 and the first enable signal ILB_EN. The ILB buffer 30 buffers an output signal of the first AND circuit 32p and an output signal of the second AND circuit 32n.

In the comparative example, a circuit scale of the SST unit 230 according to the comparative example is larger than that of the SST unit 23 according to the present embodiment, which also increases power consumption, since the ILB test circuit 310 including the logic circuit 32 is provided separately from the driver circuit 25.

In the comparative example, a load on the buffer circuits 27p and 27n may increase and characteristics of a serial signal transmitted from the buffer circuits 27p and 27n to the driver circuit 25 may deteriorate, since branched paths are provided at the buffer circuits 27p and 27n of the serial signal generator circuit 24 and the branched paths are connected to the ILB test circuit 310.

In the comparative example, monitoring of a high-speed serial transmission path from a connection node of each of the branched paths in the serial signal generator circuit 24 to the driver circuit 250 side cannot be performed, since the branched paths for the ILB test circuit 310 are provided at the serial signal generator circuit 24. Thus, the monitorable range is smaller than in the present embodiment.

In this manner, according to the present embodiment, the ILB buffer 30 is connected to the output nodes of the dummy driver 29 provided in the driver circuit 25 in the SST circuit 12, and the dummy driver 29 and the ILB buffer 30 constitute the ILB test circuit 31. With this, a circuit scale of the ILB test circuit 31 can be reduced and power consumption can be reduced.

Since the ILB test circuit 31 according to the present embodiment is provided on a path different from the high-speed serial transmission path, the second signals SSTOUT_P and SSTOUT_N that are serial signals transmitted from the SST circuit 12 to the reception device 3 do not deteriorate.

Since the ILB test circuit 31 according to the present embodiment is disposed at the output node side of the transmission device 2, monitoring of a substantially entirety of the high-speed serial transmission path in the transmission device 2 can be performed, and monitoring precision can be improved.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the inventions.

What is claimed is

1. A semiconductor device comprising:
a first circuit configured to receive a first signal, which is a differential parallel signal, and output a second signal, which is a differential serial signal, based on the first signal, wherein
the first circuit includes:
a second circuit configured to convert the first signal to a third signal, which is a differential serial signal;
a third circuit configured to receive the third signal and output the second signal, which corresponds to the third signal;
a fourth circuit configured to receive the third signal and output a fourth signal corresponding to the third signal selectively during a predetermined operation mode; and
a fifth circuit configured to receive the fourth signal and output a fifth signal obtained by buffering the fourth signal.

2. The semiconductor device according to claim 1, wherein an operation mode of the fourth circuit turns to the predetermined operation mode in accordance with a first enable signal that is input to the fourth circuit turning a first predetermined logic level.

3. The semiconductor device according to claim 2, wherein the fourth circuit is configured to output a voltage at a fixed level when the first enable signal is at a first logic level and output the fourth signal corresponding to the third signal when the first enable signal is at a second logic level, which is the first predetermined logic level.

4. The semiconductor device according to claim 3, further comprising:
a power-supply circuit configured to supply, to the third and fourth circuits, a power-supply voltage at a first level when the first enable signal is at the first logic level and at a second level higher than the first level when the first enable signal is at the second logic level.

5. The semiconductor device according to claim 3, wherein
the third circuit includes a first node that is at a high impedance when a second enable signal is at a second predetermined logic level,
the fourth circuit includes a second node that is at a high impedance when the first enable signal is at the second logic level and the second enable signal is at the second predetermined logic level, and
the first node and the second node are electrically connected.

6. The semiconductor device according to claim 1, wherein
the first circuit includes two or more of the fourth circuits, the fifth circuit is connected to at least one of the fourth circuits among the two or more fourth circuits.

7. A transmission device comprising:
the semiconductor device according to claim 1; and
a converter circuit configured to output the first signal to the semiconductor device.

8. The transmission device of claim 7, wherein the converter circuit is configured to convert a sixth signal, which is a parallel signal of a first bit string to the first signal, which is a differential parallel signal of a second bit string having a smaller number of bits than the first bit string, and output the first signal.

9. A semiconductor device comprising:
a source serial termination (SST) circuit configured to receive a first signal, which is a differential parallel signal, and output a second signal, which is a differential serial signal, based on the first signal, wherein
the SST circuit includes:
a serial signal generator circuit configured to convert the first signal to a third signal, which is a differential serial signal;
one or more first driver circuits configured to receive the third signal and output the second signal, which corresponds to the third signal;
one or more second driver circuits configured to receive the third signal and output a fourth signal corresponding to the third signal selectively during a predetermined operation mode; and
an internal loop block (ILB) buffer circuit configured to receive the fourth signal and output a fifth signal obtained by buffering the fourth signal.

10. The semiconductor device according to claim 9, wherein an operation mode of at least one of the one or more second driver circuits turns to the predetermined operation mode in accordance with a first enable signal that is input thereto turning a first predetermined logic level.

11. The semiconductor device according to claim 10, wherein the at least one of the one or more second driver circuits is configured to output a voltage at a fixed level when the first enable signal is at a first logic level and output the fourth signal corresponding to the third signal when the first enable signal is at a second logic level, which is the first predetermined logic level.

12. The semiconductor device according to claim 11, further comprising:
a power-supply circuit configured to supply, to the one or more first driver circuits and the one or more second driver circuits, a power-supply voltage at a first level when the first enable signal is at the first logic level and at a second level higher than the first level when the first enable signal is at the second logic level.

13. The semiconductor device according to claim 12, wherein
the power-supply circuit is configured to supply, to the serial signal generator circuit, a power-supply voltage at the second level.

14. The semiconductor device according to claim 11, wherein
at least one of the one more first driver circuits includes a first node that is at a high impedance when a second enable signal is at a second predetermined logic level,
at least one of the one or more second driver circuits includes a second node that is at a high impedance when the first enable signal is at the second logic level and the second enable signal is at the second predetermined logic level, and
the first node and the second node are electrically connected.

15. The semiconductor device according to claim 9, wherein the predetermined operation mode is an operation mode when the semiconductor device performs an ILB test.

16. The semiconductor device according to claim 15, further comprising:
a reception circuit configured to receive the fifth signal, wherein
the semiconductor device performs the ILB test based on the fifth signal received by the reception circuit.

17. The semiconductor device according to claim 9, wherein
the SST circuit includes a plurality of the first driver circuits, and
the number of the first driver circuits is equal to or greater than the number of the one or more second driver circuits.

18. A transmission device comprising:
the semiconductor device according to claim 9; and
a converter circuit configured to output the first signal to the semiconductor device.

19. The transmission device of claim 18, wherein the converter circuit is configured to convert a sixth signal, which is a parallel signal of a first bit string to the first signal, which is a differential parallel signal of a second bit string having a smaller number of bits than the first bit string, and output the first signal.

20. The transmission device of claim 19, wherein the converter circuit is configured to perform a feed forward equalization (FFE) with respect to the sixth signal to generate the first signal.
